(19) United States
(12) Patent Application Publication
(10) Pub. No.: US 2020/0217971 A1
(43) Pub. Date: Jul. 9, 2020

(54) METHOD FOR LOCK LOSS AND RECAPTURING, AND TERMINAL DEVICE

(71) Applicant: SZ DJI TECHNOLOGY CO., LTD., Shenzhen (CN)

(72) Inventors: Wei ZHANG, Shenzhen (CN); Liuzheng CUI, Shenzhen (CN); Jianyu SONG, Shenzhen (CN)

(21) Appl. No.: 16/806,824

(22) Filed: Mar. 2, 2020

Related U.S. Application Data
(63) Continuation of application No. PCT/CN2017/100163, filed on Sep. 1, 2017.

(51) Int. Cl. G01S 19/24; G01S 19/29; G01S 19/37; G01S 19/23

(52) U.S. Cl. CPC G01S 19/246; G01S 19/235; G01S 19/37; G01S 19/29

(57) ABSTRACT

A lock loss recapture method includes acquiring a signal transmission time range of a target satellite, determining a code phase search range based on the signal transmission time range, acquiring a carrier frequency search range of the target satellite, and tracking a signal of the target satellite in response to the code phase search range satisfying a first condition and the carrier frequency search range satisfying a second condition.

### CROSS-REFERENCE TO RELATED APPLICATION

This application is a continuation of International Application No. PCT/CN2017/100163, filed on Sep. 1, 2017, the entire content of which is incorporated herein by reference.

### TECHNICAL FIELD

The present disclosure relates to the field of satellite navigation technology, and more specifically, to a method for lock loss and recapturing (lock loss recapture) and a terminal device.

### BACKGROUND

The global navigation satellite system (GNSS) can be used to achieve the functions of positioning and navigation, and a user device working in conjunction with the GNSS can receive the navigation information and measurement values needed for the positioning by performing data processing on the received satellite signals, and complete the positioning operation and the navigation task. In the process of positioning and navigation, the receiver needs to estimate the carrier Doppler and pseudocode phase of the satellite signal more accurately in order to continuously tracking the navigation satellite signal.

However, when the user device is crossing a bridge hole or urban canyon, most or all satellite signals may lose lock. At this time, there are not enough satellites to perform the positioning and decoding, and the current receiver's position and velocity range may be estimated based on the position and velocity information of the receiver before the loss of lock, the lockout time, and the constraints of the receiver application scenario. Combining the position and velocity information of the satellite, the Doppler and pseudocode phase range of the lost satellite signal may be estimated, and a two-dimensional (2D) capture search may be performed within the range. After the capture is successful, the satellite may be tracked.

The estimated current receiver's position and velocity range may be relative large under the situation described above. Therefore, in order to recapture the satellite signal, the GNSS receiver may need to set a larger carrier Doppler and code phase search range, resulting in a slower lock loss recapture speed.

### SUMMARY

In accordance with the disclosure, there is provided a lock loss recapture method including acquiring a signal transmission time range of a target satellite, determining a code phase search range based on the signal transmission time range, acquiring a carrier frequency search range of the target satellite, and tracking a signal of the target satellite in response to the code phase search range satisfying a first condition and the carrier frequency search range satisfying a second condition.

Also in accordance with the disclosure, there is provided a terminal including a memory storing a program and a processor configured to execute the program to acquire a signal transmission time range of a target satellite, determine a code phase search range based on the signal transmission time range, acquire a carrier frequency search range of the target satellite, and track a signal of the target satellite in response to the code phase search range satisfying a first condition and the carrier frequency search range satisfying a second condition.

Also in accordance with the disclosure, there is provided a computer-readable recording medium storing a computer program that, when executed by a computer, causes the computer to acquire a signal transmission time range of a target satellite, determine a code phase search range based on the signal transmission time range, acquire a carrier frequency search range of the target satellite, and track a signal of the target satellite in response to the code phase search range satisfying a first condition and the carrier frequency search range satisfying a second condition.

### BRIEF DESCRIPTION OF THE DRAWINGS

FIG. 1 is a structural diagram of using an unmanned aerial vehicle to assist a receiver in receiving satellite signals according to an embodiment of the present disclosure.

FIG. 2 is a diagram illustrating a lock loss recapture method according to an embodiment of the present disclosure.

FIG. 3 is a flowchart illustrating the lock loss recapture method according to an embodiment of the present disclosure.

FIG. 4 is a flowchart illustrating the lock loss recapture method according to an embodiment of the present disclosure.

FIG. 5 is a flowchart illustrating the lock loss recapture method according to an embodiment of the present disclosure.

FIG. 6 is diagram illustrating a terminal according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure.

In the specification, claims, and accompanying drawings of the present disclosure, the terms “first,” “second,” “third,” “fourth,” and the like (if exist) are intended to distinguish between similar objects but do not necessarily indicate an order or sequence. It should be understood that the data termed in such a way are interchangeable in proper circumstances so that the embodiments of the present disclosure described herein can be implemented, for example, in orders other than the order illustrated or described herein. Moreover, the terms “include,” “contain” and any other similar expressions mean to cover the non-exclusive inclusion, for example, a process, method, system, product, or device that includes a list of steps or units, and are not necessarily limited to those steps or units that are explicitly listed, but may include other steps or units not explicitly listed or inherent to such a process, method, system, product, or device.

In a global navigation satellite system (GNSS), the navigation satellite can perform a spread spectrum modulation on the navigation message data using a pseudo-random code sequence, and broadcast the navigation message data at different frequency points after a carrier modulation. Due to factors such as satellite movement, receiver movement, satellite clock drift, and receive clock drift, the satellite signal received by the receiver may generate a Doppler shift. If the receiver needs to obtain movement information such as its position, velocity, and time, the receiver needs to continuously track the navigation satellite signal, obtain carrier and pseudo-distance observation, and demodulate the navigation message. As such, the GNSS receiver needs to first accurately estimate the carrier Doppler and the pseudo code phase of the satellite signal.

However, when the receiver is in an occluded environment during movement or encounters sudden interference, the satellite signal may not be tracked. When the signal is recovered, the satellite signal needs to be recaptured, and the search range of the carrier Doppler and the code phase obtained indirectly through the receiver's current position and velocity may directly affect the speed of the recapture. As such, in order to improve the speed of the lost lock recapture, it may be necessary to obtain a more accurate movement information, such as the position, velocity, and time of the receiver.

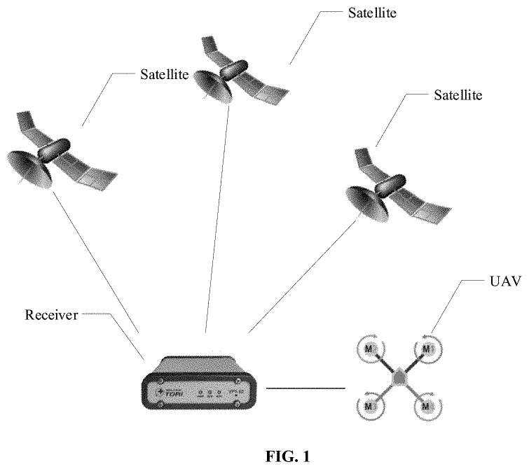

As shown in FIG. 1, the satellites can perform a spread spectrum modulation on the navigation message data using a pseudo-random code sequence, and broadcast the navigation message data at different frequency points after a carrier modulation. The receiver receives the signals from the satellites, but sometimes the receiver may not be able to track the locked satellite signal when the receiver is in an occluded environment. In this case, an unmanned aerial vehicle (UAV) may be used to assist the receiver in acquiring information such as the position and velocity of the receiver itself to enable to receiver to recapture and track the satellite signal.

In order to improve the speed of the lock loss recapture of the satellite signal, an embodiment of the present disclosure provides a lock loss recapture method which may obtain a relatively accurate receiver position and velocity information through the UAV positioning, combine the position and velocity information of the satellite to obtain a relatively smaller range of the carrier Doppler and code phase search range, and capture and track the satellite signal based on the search range, thereby improving the lock loss recapture speed.

In the present embodiment, in the process of the lock loss recapture, the method of using the UAV positioning to provide a more accurate receiver position and velocity information may also be applied to other aspects, such as measuring the distance between two objects, which is not limited herein.

The following takes a UAV as an example to describe the method of lock loss recapture in combination with a specific application scenario.

When the receiver is crossing a bridge hole or urban canyon, most or all satellite signals may lose lock. At this time, there are not enough satellites to perform the positioning and decoding. Therefore, it may not be possible to obtain a more accurate information such as the position and velocity of the receiver. As such, the current receiver's position and velocity range may be estimated and combined with the position and velocity information of the satellite, and a relative large search range for the Doppler and pseudocode phase range may be set for the capture search. However, the lock loss recapture speed may be slow. UVAs can use information from a variety of sensors, such as GNSS receivers, inertial measurement units (IMUs), barometers, visual sensors, ultrasound, etc. for a combined positioning to provide more accurate position and velocity information.

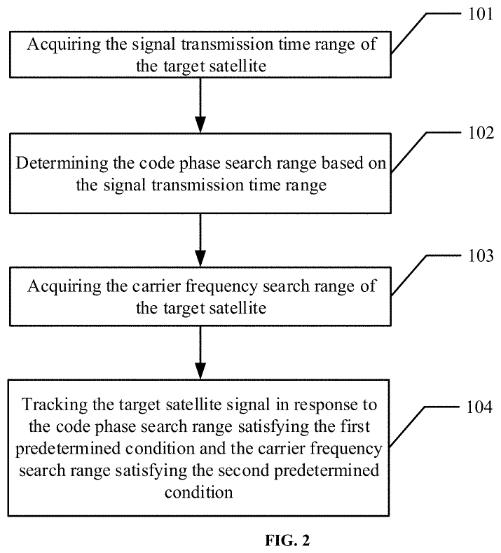

The specific process in the embodiment of the present disclosure is described below. Referring to FIG. 2, which is a diagram illustrating a lock loss recapture method according to an embodiment of the present disclosure. The method is described in detail below.

101, acquiring a signal transmission time range of a target satellite.

In the present embodiment, the signal transmission time range may be determined based on the acquired transmission time of the target satellite and a parameter error range. The signal transmission time corresponds to the receiver's reception time, and the distance between the satellite and the receiver can be calculated in different manners. Since the reception time is known, the transmission time may be acquired. The position of the satellite can be acquired by the satellite ephemeris, and the position of the receiver can be acquired by combining positioning information. There are many methods for combining positioning, which can be acquired by one or more position devices, such as inertial navigation, visual sensors, or ultrasound.

In some embodiments, factors such as the various errors, the ranges of the various errors, and the propagation time of the signal need to be taken into account to acquire a more accurate range of the signal transmission time.

Different manners may be used to acquire the range of the signal transmission time.

In some embodiments, the pseudo-distance may be acquired through the geometric distance between the receiver and the target satellite and a first type of error parameters, the signal transmission time may be determined based on the pseudo-distance, and the range of the signal transmission time may be acquired by combining a parameter error range and the signal transmission time.

In some embodiments, the error range of various parameters may be directly used when calculating the signal transmission time based on the current time and the first type of error parameter, and the range of the signal transmission time may be directly acquired by combining the parameter and the parameter error range.

102, determining a code phase search range based on the range of the signal transmission time.

In the present embodiment, each frequency point of the GNSS may have different code periods and there may be different numbers of chips. The search range of the code phase may be acquired based on the range of the signal transmission time, the number of chips, and a formula.

In some embodiments, for a frequency point of GPS L1, the code phase search range can be calculated based on the following formula:

[(t₁−floor(t₁))×M,(t₂−floor(t₂))×M],

where the unit of time is in milliseconds (ms), t₁ is the lower limit of the range of the signal transmission time, t₂ is the upper limit of the range of the signal transmission time, floor is the round-down function, and M is the number of chips corresponding to each frequency point of the GNSS.

103, acquiring a carrier frequency search range of the target satellite.

In the present embodiment, the search range of the carrier frequency can be determined based on the carrier Doppler and a calculation error range. The carrier Doppler can be calculated based on the position and velocity of the satellite at the current time and the position and velocity of the receiver acquired by the UAV based on the satellite ephemeris and the current time.

In addition, the carrier Doppler can be calculated based on the position and velocity of the satellite at the current time, the position and velocity of the receiver acquired by the UAV, the satellite clock speed, and the receiver clock drift based on the satellite ephemeris and the current time.

In the present embodiment, the position of the satellite can be acquired at the time of acquiring the satellite transmission time, the velocity of the satellite can be simultaneously acquired when calculating the position of the satellite, and the receiver clock drift can be acquired when acquiring the receiver velocity.

Different manners may be used to acquire the search range of the carrier frequency.

In some embodiments, the carrier frequency may be determined based on a second type of error parameter, and the search range of the carrier frequency can be acquired by combining the carrier frequency and an error range of the second type of error parameter. The second type of error parameter may include a projection component of the velocity vector on the position vector, the satellite clock speed, and the receiver clock.

In some embodiments, when calculating the carrier frequency by substituting the various parameters, the error range of the various parameters may also be substituted, and the search range of the carrier frequency may be directly acquired by combining the error ranges of the various parameters and the parameters.

104, tracking a signal of the target satellite in response to the search range of the code phase satisfying a first predetermined condition and the search range of the carrier frequency satisfying a second predetermined condition.

In the present embodiment, when the search ranges of the carrier frequency and the code phase are less than an interval of a traction range of the tracking satellite signal, the satellite signal may be tracked. For example, for a frequency point of GPS L1, the uncertainty range of the carrier frequency may be less than ±250 Hz (e.g., the first predetermined condition), the uncertainty range of the code phase may be less than ±0.5 chip (e.g., the second predetermined condition), and tracking can be performed when the carrier frequency and the code phase satisfy the two predetermined conditions. For other carriers, different carrier frequency ranges and codes phase ranges may be determined based on different carriers, that is, there are different first predetermined conditions and second predetermined conditions.

In the present embodiment, the time range of the signal transmission of a target satellite is first acquired, and then the search range of the code phase is determined based on the range of the signal transmission time. After the search range of the carrier frequency of the target satellite is acquired, the signal of the target satellite is tracked in response to the search range of the code phase satisfying a first predetermined condition and the search range of the carrier frequency satisfying a second predetermined condition.

By using the method described above, an aircraft, such as a UAV, provided by embodiments of the disclosure may be used to perform combined positioning to provide a more accurate position and velocity information. By using the more accurate position and velocity information, the Doppler and code phase search range of the satellite signal may be reduced, thereby significantly improving the lock loss recapture speed of the receiver.

In some embodiments, tracking the signal of the target satellite includes determining a current code phase based on a first predetermined rule and the search range of the code phase; determining a current carrier frequency based on a second predetermined rule and the search range of the carrier frequency; and tracking the signal of the target satellite based on the current code phase and the current carrier frequency.

In the present embodiment, the current code phase may be determined from the code phase search range based on the code phase search range and the first predetermined rule corresponding to the code phase. Similarly, the current carrier frequency may be determined from the carrier frequency search range based on the second predetermined rule and the carrier frequency search range determined based on the first predetermined rule corresponding to the current carrier frequency. Subsequently, the satellite signal may be tracked based on the specific current code phase and the current carrier frequency. The first predetermined rule may be combined with the code phase search range, for example, the median value, maximum value, minimum value, etc. of the code phase search range. The first predetermined rule may be combined with the carrier frequency search range, for example, the median value, maximum value, minimum value, etc. of the carrier frequency search range

In some embodiments, the lock loss recapture method further includes, after tracking the signal of the target satellite based on the current code phase and the current carrier frequency, acquiring a predetermined code phase and a predetermined carrier frequency; determining the target satellite signal is locked in response to the difference between the current code phase and the predetermined code phase is less than or equal to a predetermined value, and the difference between the current carrier frequency and the predetermined carrier frequency is less than or equal to a predetermined value within a first predetermined time period; and determining whether the lock loss time exceeds a predetermined time period in response to the error between the current code phase and the predetermined code phase is greater than a predetermined value, or the difference between the current carrier frequency and the predetermined carrier frequency is greater than a predetermined value within the first predetermined time period.

In the present embodiment, since the physical quantities of the carrier frequency and the code phase may directly affect the capturing and tracking of the satellite signal, therefore, after the satellite signal is tracked, the receiver may continuously reproduce the carrier frequency and the code phase of the accurate satellite signal to determine whether the satellite signal is continuously locked. The purpose of the reproduction is to determine whether the error between the current carrier frequency and the error between the predetermined carrier frequency and the code phase after a period of time and the predetermined code phase after a period of time is less than a predetermined value. If the error is less than the predetermined value, it may indicate that the carrier frequency and the current code phase have no significant deviation from the corresponding predetermined carrier frequency and the predetermined code phase. Therefore, the satellite signal may be consider to have been continuously locked.

In some embodiments, the satellite signal may be consider to have been continuously locked if the error between the code phase search range and the predetermined code phase is less than the predetermined value for a period of time, and the error between the carrier frequency search range and the preset carrier frequency is less than the predetermined value for a period of time.

If the error between the current code phase and the predetermined code phase is greater than a predetermined value, or the difference between the current carrier frequency and the predetermined carrier frequency is greater than a predetermined value, it may indicate that the carrier frequency and code phase data after the period of time is already unreliable, indicating that the satellite signal has lost lock. As such, it may be needed to determine whether the lock loss time exceeds the predetermined time period.

In the present embodiment, after the signal of the target satellite is tracked, the method further determines whether the satellite signal is locked. After tracking the satellite signal, it is possible that the tracking may be a pseudo-tracking or the satellite signal may be lost after the satellite signal is tracked. Therefore, the method of the present embodiment further determines that the satellite signal is locked, such that the carrier frequency and the code phase acquired at the time may be confirmed to be reliable.

Moreover, the process of strictly controlling the satellite signal to be tracked and locked in the present embodiment may avoid meaningless carrier frequency and code phase data, and does not affect subsequent results acquired by the data, thereby improving the reliability and security of the technical solution.

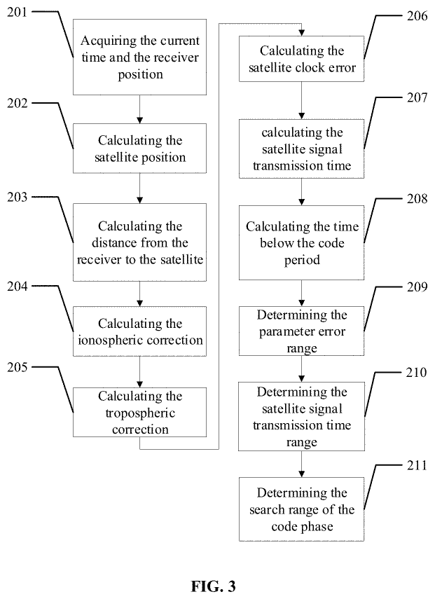

FIG. 3 is a flow chart showing an example method of acquiring the search range of the code phase (102 in FIG. 2), which is described in more detail below.

201, acquiring the current time and the position of the receiver.

In some embodiments, acquiring the geometric distance from the receiver to the target satellite may be an optional step in calculating the transmission time, before which the current time, the position of the receiver, and the position of the satellite may need to be acquired first. Since the receiver has lost lock at this time, the current time may be the local time maintained by the receiver, and the local time may have been synchronized with the GNSS satellite navigation time (e.g., a GPS time) before losing the lock. The position of the receiver may be acquired by one or more positioning devices, such as inertial navigation, visual sensors, ultrasound, etc., which is not limited herein. Further, the position of the satellite may be calculated based on the satellite ephemeris and the current time acquired by the receiver before losing the lock.

202, calculating the satellite position.

In the present embodiment, the satellite position may be calculated based on the satellite ephemeris and the current time, and the receiver may have acquired the satellite ephemeris before losing the lock.

203, calculating the distance from the receiver to the satellite.

The distance between the receiver and the satellite may be calculated based on the following formula.

r^{j}=\sqrt{(x−x^{j})²+(y−y^{j})²+(z−z^{j})²},

where x, y, and z are the coordinates of the receiver in the earth-centered and earth fixed (ECEF) coordinate system, x^{j}, y^{j}, and z^{j} represent the position of the target satellite. The transmission time may be calculated based on the distance and the current time of the receiver.

In some embodiments, the actual distance traveled by the signal may not equal the geometric distance described above but may include pseudo-distance with various errors. Thus, the following process may be used to make a more accurate distance measurement, which may result in a more accurate transmission time. More specifically, the following formula may be used.

tₛ^{j}=tᵢr^{j}/c,

where tᵢ is the current time corresponding to the signal transmission time, r^{j} is the distance from the receiver to the satellite, and c is the speed of light.

204, calculating the ionospheric correction.

The error of the propagation effect of the satellite signal as it passes through the ionosphere exists, therefore, there are different ionospheric delay correction method and models, such as the dual-frequency correction method, the modelling method, etc. In the present embodiment, the ionospheric correction may be calculated by using an ionospheric correction parameter and the corresponding ionospheric correction model, and the receiver may have acquired the ionospheric correction parameter before losing the lock. However, it should be noted that other methods may be used to calculate the ionospheric correction.

205, calculating the tropospheric correction.

The tropospheric correction may be calculated by using the appropriate tropospheric models, such as the Sastomain model, the Hopfield model, etc. The Hopfield model is a model based on the assumption of atmospheric spherical stratification. Compared with the conventional tropospheric refraction integral correction method, the Hopfield model may effectively improve the accuracy of correcting low elevation wave refraction. However, it should be noted that other methods may be used to calculate the tropospheric correction.

206, calculating the satellite clock error.

The receiver may have acquired the satellite clock error parameter before losing the lock, and the clock error of the target satellite may be acquired by the clock error parameter.

In some embodiments, calculating the error in the pseudo-distance may include one or more of the ionospheric correction, the tropospheric correction, and the satellite clock error. Further, it may also include the multipath error, the relativistic error, etc.

207, calculating the transmission time of the satellite signal.

In some embodiments, the signal transmission time may be indirectly acquired by calculating the pseudo-distance.

In some embodiments, the pseudo-distance of the receiver at the receiving time may be acquired based on the geometric distance of the receiver to the target satellite and the first type of error parameter. The signal transmission time may be calculated by calculating the pseudo-distance and acquiring the current time of the receiver. Subsequently, the range of the signal transmission time may be acquired based on the parameter error range of each parameter, that is, the error range of the geometric distance, the error range of the first type of error parameter, and the error range of the current time.

It may be understood that, in addition to calculating the satellite signal transmission time using the method described above, other methods may be used to calculate the satellite signal transmission time, which is not limited herein.

In one embodiment, the specific process of acquiring the signal transmission time by using pseudo-distance calculation may be as follows.

The pseudo-distance p^{j} of the receiver at the receiving time for the target satellite may be calculated based on the following formula.

ρ^{j}=r^{j}+c·Δtᵢ−c·Δtⱼ+Δᵢₒₙₒ+Δₜᵣₒₚ+Δₘₚ,

where r^{j} is the distance from the receiver to the satellite, Δtᵢ is the clock error of the receiver, Δt ⱼ is the clock error of the target satellite, Δᵢₒₙₒ is the ionospheric correction, Δₜᵣₒₚ is the tropospheric correction, Δₘₚ is the error caused by the multipath effect and c may be the speed of light.

Further, the pseudo-distance p^{j} may be expressed as follow.

ρ^{j}=c·(tᵢ−tₛ^{j}),

where tᵢ is the receiving time of the receiver.

The calculation formula for the signal transmission time can be acquired by combining the above two formulas as follows.

tₛ^{j}=tᵢ−Δtᵢ+Δtⱼ−(r^{j}+Δᵢₒₙₒ+Δₜᵣₒₚ+Δₘₚ)/c

208, calculating the time below the code period.

The time below the code period refers to the remainder of dividing the signal transmission time by the code period, and may be converted to the code phase. Frequency points of various GNSSs may have different code periods. Taking GPS as an example, the code period of the L1 C/A code on the GPS L1 frequency point may be 1 millisecond, and the code period of the L2CM code on the L2 frequency point may be 20 milliseconds. For the GPS L1 C/A code, the portion of the signal transmission time below 1 millisecond may be the code phase of the satellite signal. For the L2 code, the portion of the signal transmission time within 20 milliseconds may be the code phase of the satellite signal.

209, determining the parameter error range.

In the present embodiment, the parameter error range may refer to the error range of each factor needed to calculate the signal transmission time, which may include the error range of the geometric distance. The error range may include one or more of the error range of the first type of error parameter and the error range of the current time. The first type of error parameter may include one or more of the receiver clock error, the satellite clock error, the ionospheric correction, the tropospheric correction, and the multipath effect error. In some embodiments, the error range of the geometric distance may be determined by the combined positioning error of the UAV and the calculation error of the satellite position. The error of the combined positioning may be determined by the accuracy of the device providing the combined positioning, which may be an error that gradually spreads over time. The receiver may be configured to determine the error range between the current time and the receiver clock error. In particular, the receiver may be configured to determine the error between the receiver time and the GNSS time based on the clock drift of the crystal oscillator. In addition, the satellite clock error may be corrected by the satellite clock error parameter of the, for example, the calculation error may be less than 3 m. The error on r^{j} may be determined by the UAV combined positioning error and the satellite position calculation error, for example, the satellite position calculation error may be less than 2 m. The ionospheric correction Δᵢₒₙₒ may be calculated from the ionospheric parameter and the corresponding model, for example, the error may be less than 5 m. The tropospheric correction Δₜᵣₒₚ may be calculated by the tropospheric correction mode, for example, the error may be less than 1 m. The multipath effect error Δₘₚ may not be calculated, however, the range of the multipath effect error may be determined based on the hardware design and the algorithm design of the receiver.

210, determining the satellite signal transmission time range.

In the present embodiment, the range of the signal transmission time may be calculated from the specific signal transmission time and the parameter error range.

In some embodiments, the range of the signal transmission time may be acquired directly from the calculation of various parameters with errors.

211, determining the search range of the code phase.

The search range of the code phase may be calculated using a formula based on the range of the signal transmission time determined in 210, and the code phase or the number of chips of the carrier.

In some embodiments, the search range of the code phase may be calculated based on the following formula.

[(t₁−floor(t₁))×M,(t₂−floor(t₂))×M],

where the unit of time is milliseconds (ms), t₁ is the lower limit of the range of the signal transmission time, t₂ is the upper limit of the range of the signal transmission time, floor is the round-down function, and M is the number of chips corresponding to each frequency point of the GNSS.

It may be understood that different carriers may be modulated with different ranging codes. For example, the modulation signal for the L1 carrier may be the C/A code or the P code, and the modulation code for the L2 carrier may only be the P code. As such, the period and number of chips after the carrier modulation may be different, and the value of M may also be different.

For the L1C/A code on the L1 carrier frequency, the code period may be 1 millisecond, the number of chips may be 1023, and thus M may be 1023. For other carriers, for example, if the L2 carrier is modulated by the P code, the number of the chips of the carrier signal may be 10230, and M may be 10230 at this time. As such, the value of M is not limited herein.

It may be understood that, in some embodiments, 201, 202, 203, 204, 205, 206, 207, 208, 209, 210, 211 or any other method may be used to respectively acquire the current time and receiver position, the satellite position, the distance from the receiver to the satellite, the ionospheric correction, the tropospheric correction, the satellite clock error, the satellite signal transmission time, the time within the code period, the parameter error range, the satellite signal transmission time range, and the code phase search range.

In some embodiments, the current time and receiver position may be acquired by performing 201 and the satellite position may be acquired by performing 202. In addition, 203 may be performed to calculate the distance from the receiver to the satellite.

In some embodiments, 207 may be separately performed based on 201 to 206 to calculate the transmission time of the satellite signal.

In some embodiments, 210 may be separately performed based on 207 and 209 to determine the range of the signal transmission time.

In some embodiments, 211 may be performed based on 210 to determine the search range of the code phase.

In other words, all steps in the present embodiment can be a complete embodiment through the steps, or steps that are internally related to each other can be integrated into a complete embodiment.

In the present embodiment, the signal transmission time can be acquired in two methods. Both calculation method take into account the deviation of the results due to various calculation errors and measurement errors. During the calculation process, the errors may be corrected to the greatest extent to make the acquired results more accurate. Further, the various methods to acquire the results may increase the diversity of the technical solution of the present disclosure and improve the implementability of the technical solution of the present disclosure.

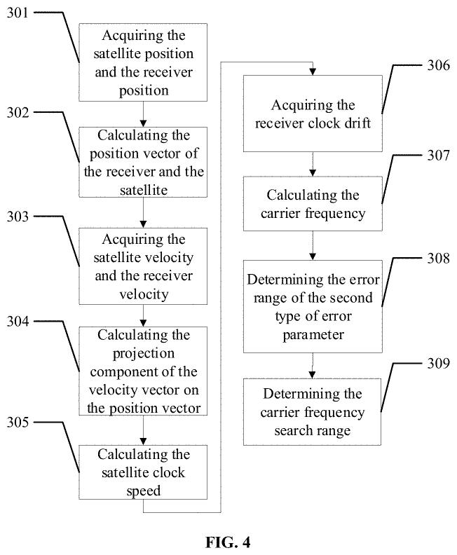

FIG. 4 is a flow chart showing an example method of acquiring the search range of the carrier frequency, which is described in more detail below.

301, acquiring the satellite position and the receiver position.

The satellite position may be acquired when calculating the carrier frequency or when calculating the transmission time. The satellite position may be calculated from the current time and the satellite ephemeris, and the velocity of the satellite may be acquired at the same time. Further, the receiver position and the receiver velocity may be acquired by the combined position performed by the UAV.

302, calculating the position vector of the receiver and the satellite.

In some embodiments, the position vector from the receiver to the satellite may be calculated based on the following formula.

$$\begin{matrix}{e}^{j} = ( {e}_{x}^{j} , {e}_{y}^{j} , {e}_{z}^{j} ) \\ = ( \frac{x - {x}^{j}}{{r}^{j}} , \frac{y - {y}^{j}}{{r}^{j}} r , \frac{z - {z}^{j}}{{r}^{j}} ) ,\end{matrix}$$

where eₓ^{j},e_{y}^{j},e_{z}^{j} are the coordinates of the position vector, x, y, z represent the position of the receiver, x^{j},y^{j},z^{j} represent the position of the target satellite, and r^{j} is the geometric distance from the receiver to the target satellite.

303, acquiring the satellite velocity and the receiver velocity.

The satellite velocity may be acquired at the same time as the satellite position is calculated, and the receiver velocity may be provided by the combined positioning performed by the UAV.

304, calculating the projection component of the velocity vector on the position vector.

First, the relative velocity between the receiver velocity and the satellite velocity may be calculated, and then the relative velocity between the receiver and the target satellite may be calculated based on the following formula.

$$\begin{matrix}{v}_{r}^{j} = ( {vx}_{r}^{j} , {vy}_{r}^{j} , {vz}_{r}^{j} ) \\ = ( vx - {vx}^{j} , vy - {vy}^{j} , vz - {vz}^{j} ) ,\end{matrix}$$

where vx^{j},vy^{j},vz^{j} represent the satellite velocity, and vx,vy,vz represent the receiver velocity.

As such, the projection component of the relative velocity on the position vector may be calculated based on the relative velocity and the position vector acquired in 302. The calculation formula may be as follow.

vₑ^{j}=vᵣ^{j}·e^{j}=vxᵣ^{j}·eₓ^{j}+vyᵣ^{j}·e_{y}^{j}+vzᵣ^{j}·e_{z}^{j},

where vᵣ^{j} is the relative velocity between the receiver and the target satellite, vxᵣ^{j}, vyᵣ^{j}, vzᵣ^{j} represent the relative velocity, and eₓ^{j}, e_{y}^{j}, e_{z}^{j} represent the position vector.

305, calculating the satellite clock speed.

The satellite clock speed may be calculated by differentiating the satellite clock error. In a GPS system, the satellite clock error Δtⱼ of the target satellite at time t may be calculated as follow.

Δtⱼ=a_{f0}^{j}+a_{f1}^{j}(t−t_{oc})+a_{f2}^{j}(t−t_{oc})²+Δtᵣₗₜ^{j},

where a_{f0}^{j}, a_{f1}^{j}, a_{f2}^{j}, t_{oc} are the satellite clock error parameters, which may be acquired from the navigation message, Δtᵣₗₜ^{j} is the correction for the relativistic effect calculated from the satellite orbital parameters. The time t may be differentiated to acquire the satellite clock speed at time t.

The satellite clock speed Δ\dot{t}ⱼ may be calculated based on the following formula.

\dot{t}ⱼ=a_{f1}^{j}+2a_{f2}^{j}(t−t_{oc})+Δ\dot{t}ᵣₗₜ^{j}

306, acquiring the receiver clock drift.

The receiver clock drift may be acquired when the receiver velocity is calculated, and the receiver clock drift may not change in a short amount of time. Further, the GNSS receiver may record the receive clock drift after solving the speed before losing the lock.

307, calculating the carrier frequency.

In some embodiments, the carrier frequency may be calculated by the relative velocity of the receiver and the target satellite, and the wavelength of the carrier.

Further, the carrier frequency in the embodiment of the present disclosure may be calculated through the position vector of the receiver and the target satellite, the relative velocity of the receiver and the target satellite, the satellite clock speed, and the receiver clock drift. In addition, the receiver clock drift can be acquired at the same time when the receiver velocity is calculated. Further, the satellite clock speed may be acquired by differentiating the satellite clock error. As such, it is important to know the position of the receiver and the target satellite, the velocity of the receiver and the target satellite, and the satellite clock error.

In some embodiments, the carrier frequency may be calculated using the following formula.

f_{dopp}^{j}=−(vₑ^{j}+c·Δ\dot{t}ᵣ−c·Δ\dot{t}ⱼ)/λ^{j},

where vₑ^{j} is the projection component of the relative velocity of the receiver and the target satellite on the position vector, Δ\dot{t}ᵣ is the receiver clock drift, Δ\dot{t}ⱼ is the satellite clock speed, and λ^{j} is the carrier wavelength.

However, it should be noted that the carrier frequency may also be calculated by using other methods.

308, determining the error range of the second type of error parameter.

The error of vₑ^{j} may be determined by the receiver velocity error and the satellite velocity error. For example, the satellite velocity error may be less than 0.001 m/s, the velocity error provided by the combined positioning of the UAV may be less than 0.1 m/s, the receiver clock drift error Δ\dot{t}ᵣ may be determined by the crystal oscillator, and the satellite clock drift error Δ\dot{t}ⱼ may be ignored.

309, determining the carrier frequency search range.

In some embodiments, the search range of the carrier frequency may be determined based on the acquired carrier frequency and the parameter error range.

In some embodiments, in the process of calculating the carrier frequency, each of the parameters may be brought into the error range, and the search range of the carrier frequency may be directly acquired through the calculation of the carrier frequency. As such, the search range of the carrier frequency may be determined using various methods.

When the search range of the carrier frequency is less than the interval of the traction range of the tracking satellite signal, it may indicate that the first condition of turning into tracking is satisfied. For the frequency point of GPS L1, the uncertainty range of the carrier frequency may be less than ±250 Hz. It may be understood that for different carrier frequencies, the corresponding frequency search range may also be different. For example, the carrier frequency search range of the L2 carrier may be different from the carrier frequency search range of the L1 carrier.

It may be understood that, in some embodiments, 301, 302, 303, 304, 305, 306, 307, 308 or any other method may be used to respectively acquire the satellite position and the receiver position, the position vector, the satellite velocity and the receiver velocity, the projection component, the satellite clock speed, the receiver clock drift, the carrier frequency, and the error range of the second type of error parameter.

In some embodiments, 302 may be performed to calculate the position vector based on the satellite position and the receiver position acquired based on 301.

In some embodiments, 307 may be performed based on 301 to 306 to calculate the carrier frequency.

In some embodiments, 309 may be performed based on 307 and 380 to determine the carrier frequency search range.

In other words, all steps in the present embodiment can be a complete embodiment through the steps, or steps that are internally related to each other can be integrated into a complete embodiment.

In the present embodiment, the Doppler frequency shift may be generated by the satellite signal received by the receiver due to the effects of moving speeds such as the satellite operation, the receiver movement, the satellite clock drift, and the receiver clock drift. Therefore, in order to improve the reliability of the carrier frequency, the influence of these factors needs to be considered. In the present embodiment, since the receiver has lost lock, some physical quantities necessary to calculate the carrier frequency may not be directly acquired. However, the physical quantities that may not be acquired after the receive has lost lock may be acquired through physical quantities that may not change drastically in a short period of time. There are seemingly many physical quantities in the calculation formula, however, some physical quantities may have a close relationship and may be derived from each other. In addition, some physical quantities may have a high utilization rate, and they may be used repeatedly throughout the process. For example, the current time, the position of the receiver and satellite, the receiver clock error, and the satellite clock error are used multiple times. As such, data acquisition may be convenient, thereby improving the flexibility and practicality of the technical solution of the present disclosure.

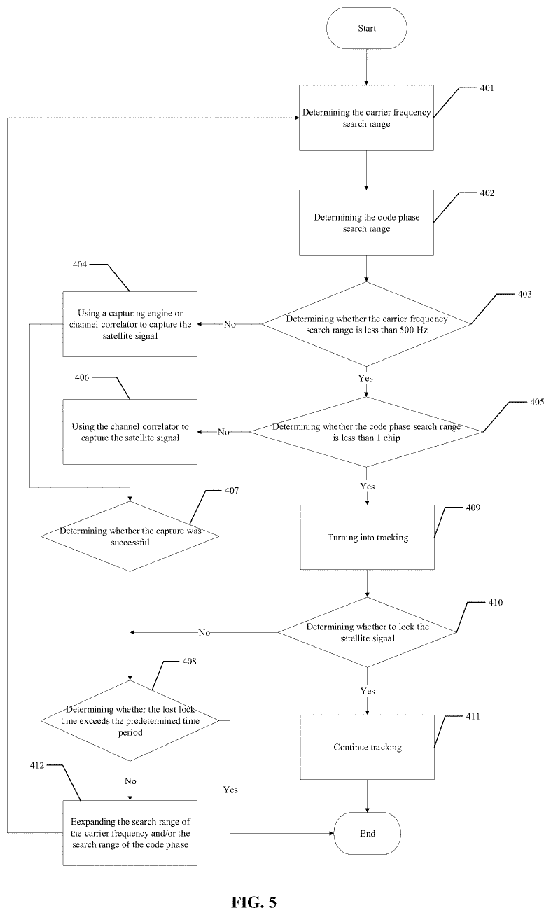

The present disclosure provides a lock loss recapture method where different processes may be performed in the lock loss recapture process based on the size of the code phase search range and the carrier frequency search range, as shown in FIG. 5 and described in detail below.

401, determining the carrier frequency search range.

This has been described in the method embodiments provided above and details will not be described herein again.

402, determining the code phase search range.

This has been described in the method embodiments provided above and details will not be described herein again. It should be noted that there is no fixed sequence for determining the carrier frequency search range and the code phase search range. That is, 401 may be performed first, or 402 may be performed first, or 401 and 402 may be performed simultaneously, which is not limited herein.

403, determining whether the carrier frequency search range satisfies the second predetermined condition.

When the carrier frequency search range is less than the traction range of the tracking satellite signal, it may indicate that the first condition of turning into tracking is satisfied. That is, for the L1 frequency point, when the search range of the carrier frequency is less than ±250 Hz, 405 may be performed. Otherwise, 404 may be performed.

404, using a capturing engine or channel correlator to capture the satellite signal.

In some embodiments, the capturing the satellite signal, 406 may be performed to determine whether the capture was successful.

405, determining whether the code phase search range satisfies the first predetermined condition.

In some embodiments, controlling the search range of the code phase within ±0.5 chip may be one of the conditions for tracking the satellite signal. If the first predetermined condition is satisfied, 409 may be performed to turn into tracking. Otherwise, 406 may be performed.

406, using the channel correlator to capture the satellite signal.

In some embodiments, after capturing the satellite signal, 407 may be performed to determine whether the capture was successful.

407, determining whether the capture was successful.

In some embodiments, if the satellite signal was successfully captured, 409 may be performed directly to track the satellite signal. However, if the satellite signal was not successfully captured, 408 may be performed to determine whether the lock loss time exceeds a predetermined time period.

408, determining whether the lock loss time exceeds the predetermined time period.

If the lock time exceeds the predetermined time period, the process may be terminated. If not, 412 may be performed, and the current frequency search range and/or the search range of the code phase may be continuously expanded. The expanded range may be predetermined or fixed. In some embodiments, the predetermined time period may be determined based on the actual needs of the receiver. The predetermined time period may be less than or equal to 1 minute, and the specific time period may be set in advance by the user. Further, the predetermined time period may be adjusted automatically by the predetermined rules of the receiver based on factors that may affect the lock loss recapture speed, such as the magnitude of the error, the sensitivity requirements of the accuracy, or the type of the receiver, which is not limited herein.

409, turning into tracking.

In some embodiments, 409 may be performed when 403 and 405 are simultaneously satisfied. That is, when the search range of the carrier frequency is less than ±250 Hz and the search range of the code phase is controlled to be within ±0.5 chip.

410, determining whether to lock the satellite signal.

In some embodiments, after the satellite signal is tracked, the receiver may continue to reproduce the accurate carrier frequency and code phase of the satellite signal to determine whether the satellite single is continuously locked. If yes, 411 may be performed to continue tracking, if not, 408 may be performed to determine whether the lock loss time exceeds the predetermined time period.

More specifically, by comparing the error between the current carrier frequency and the predetermined carrier frequency, and whether the error between the current code phase and the predetermined code phase is less than the predetermined value, it may be possible to determine whether to lock the satellite signal. The current code phase may be acquired from the search range of the code phase based on the first predetermined rule between the search range of the code phase and a specific current carrier frequency. Similarly, the current carrier frequency may also be acquired from the search range of the carrier frequency in a similar manner. Subsequently, the satellite signal may be tracked through a second-order phase-lock loop based on the current code phase and the current carrier frequency.

411, continuing tracking.

412, expanding the search range of the carrier frequency and/or the search range of the code phase.

It may be understood that, in some embodiments, 401 and 402 or any other methods may be used to determine the search range of the carrier frequency and the search range of the code phase separately.

In some embodiments, it may be possible to separately determine whether the search range of the carrier frequency satisfies the second predetermined condition based on 403, and whether the search range of the code phase satisfies the first predetermined condition based on 405 to determine whether to perform 409, that is, turning into tracking.

In some embodiments, it may be possible to separately use the capturing engine or channel correlator to capture the satellite signal based on 404 and use the channel correlator to capture the satellite signal based on 406 to determine whether to perform 407, that is, determining whether the capture was successful.

In some embodiments, it may be possible to determine whether to perform 412, that is, to further expand the search range of the carrier frequency and/or the search range of the code phase based on 408.

In other words, all steps in the present embodiment can be a complete embodiment through the steps, or steps that are internally related to each other can be integrated into a complete embodiment.

The present embodiment provides a process of lock loss recapture, and different steps may be performed based on the search range of the carrier frequency and the search range of the code phase. If the search range of the carrier frequency and the search range of the code phase are both controlled within the condition ranges, the satellite signal may be directly tracked without performing the steps such as capturing. As such, the tedious processes may be avoided and the process of lock loss recapture may be theorized and regularized, thereby greatly improving the efficiency of the lock loss recapture.

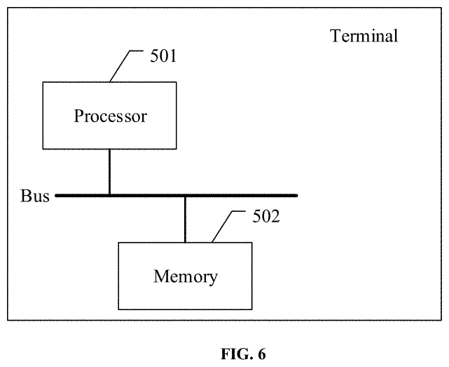

The following description is provided from the perspective of a terminal. As shown in FIG. 6, an embodiment of the terminal provided in the present disclosure includes a processor 501 and a memory 502 (the terminal may include one or more processors 501, and one processor 501 is being used as an example in FIG. 5). In some embodiments of the present disclosure, the processor 501 and the memory may be connected through a bus or other manners. In particular, a bus connection is being used as an example in FIG. 5.

The memory 502 may be configured to store software programs and modules, and the processor 501 may execute various function applications and data processing of the terminal by running the software programs and modules stored in the memory 502. The memory 502 may mainly include a program storage area and a data storage area. The program storage area may be used to store, for example, an operating system and an application required by at least one function (for example, a voice playing function, an image playing function). The data storage area may be used to store, for example, data established according to the use of the terminal (for example, audio data, phonebook). In addition, the memory 502 may include a high-speed random access memory and a nonvolatile memory, such as at least one magnetic disk memory, a flash memory, or other volatile solid-state memory.

The processor 501 may be configured to acquire the range of the signal transmission time of the target satellite; determine the search range of the code phase based on the range of the signal transmission time; acquire the search range of the carrier frequency of the target satellite; and track the signal of the target satellite in response to the search range of the code phase satisfying the first predetermined condition and the search range of the code phase satisfying the second predetermined condition.

In some embodiments, the processor 501 may be further configured to track the signal of the target satellite, which may include determining the current code phase based on the first predetermined rule and the search range of the code phase; determining the current carrier frequency based on the second predetermined rule and the search range of the carrier frequency; and tracking the signal of the target satellite based on the current code phase and the current carrier frequency.

In some embodiments, after tracking the signal of the target satellite based on the current code phase and the current carrier frequency, the processor 501 may be further configured to acquire the predetermined code phase and the predetermined carrier frequency; determine the signal of the target satellite is locked in response to the difference between the current code phase and the predetermined code phase is less than or equal to a predetermined value, and the difference between the current carrier frequency and the predetermined carrier frequency is less than or equal to a predetermined value within a first predetermined time period; and determine whether the lock loss time exceeds a predetermined time period in response to the error between the current code phase and the predetermined code phase is greater than a predetermined value, or the difference between the current carrier frequency and the predetermined carrier frequency is greater than a predetermined value within the first predetermined time period.

In some embodiments, the processor 501 may be further configured to acquire the range of the signal transmission time of the target satellite, which may include acquiring the signal transmission time of the target satellite; acquiring the parameter error range, which may include the error range of the geometric distance between the receiver and the target satellite, the error range of the first type of error parameter, and the error range of the current time; and determining the range of the signal transmission time based on the signal transmission time of the target satellite and the parameter error range.

In some embodiments, the processor 501 may be further configured to acquire the signal transmission time of the target satellite, which may include acquiring the current time of the receiver; acquiring the geometric distance between the receiver and the target satellite; estimating the pseudo-distance based on the geometric distance and the first type of error parameter; and determining the signal transmission time based on the pseudo-distance and the current time.

In some embodiments, the processor 501 may be further configured to acquire the geometric distance between the receiver and the target satellite, which may include acquiring the position information of the receiver by one or more positioning devices, which may include one or more of inertial navigation, visual sensors, or ultrasound; acquiring the satellite position information of the target satellite through a satellite ephemeris acquired by the receiver and the current time of the receiver; and acquiring the geometric distance based on the receiver position information and the satellite position information.

In some embodiments, the processor 501 may be further configured to determine the search range of the code phase based on the range of the signal transmission time, which may include acquiring the code period of the target satellite carrier; acquiring the number of chips through the code period; and determining the search range of the code phase through the code period, the number of the chips, and the range of the signal transmission time.

In some embodiments, the processor 501 may be further configured to determine the search range of the carrier frequency of the target satellite, which may include acquiring the carrier frequency of the target satellite; acquiring the error range of the second type of error parameter; and determining the search range of the carrier frequency based on the carrier frequency and the error range of the second type of error parameter.

In some embodiments, the processor 501 may be further configured to determine the carrier frequency of the target satellite, which may include acquiring the second type of error parameter; and determining the carrier frequency of the target satellite based on the second type of error parameter.

In some embodiments, the processor 501 may be further configured to use the capturing engine or the channel correlator to capture the signal of the target satellite in response to the search range of the carrier frequency not satisfying the first predetermined condition.

In some embodiments, the processor 501 may be further configured to use the channel correlator to capture the signal of the target satellite in response to the search range of the carrier frequency satisfying the first predetermined condition and the search range of the code phase not satisfying the second predetermined condition.

In some embodiments, the processor 501 may be further configured to determine whether the signal of the target satellite was successfully captured; track the signal of the target satellite in response to the signal of the target satellite being successfully captured; and determine whether the lock loss time exceeds the predetermined time period in response to the signal of the target satellite not being successfully captured.

In some embodiments, the processor 501 may be further configured to determine whether the lock loss time exceeds the predetermined time period, the predetermined time period may be the time period from when the receiver stopped receiving the satellite signal to when the satellite signal is successfully tracked again; terminate the lost lock capturing in response to the lock loss time exceeding the predetermined time period; and expand the search range of the carrier frequency and/or the search range of the code phase in response to the lock loss time not exceeding the predetermined time period.

All or some of the foregoing embodiments may be implemented through software, hardware, firmware, or any combination thereof. When software is used to implement the embodiments, the foregoing embodiments may be implemented completely or partially in a form of a computer program product.

The computer program product includes one or more computer instructions. When the computer program instructions are loaded or executed on a computer, the procedure or functions according to the embodiments of the present invention are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a web site, computer, server, or data center to another web site, computer, server, or data center in a wired (for example, a coaxial cable, a fiber optic cable, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, and a magnetic tape), an optical medium (for example, a digital versatile disc (DVD)), or a semiconductor medium. The semiconductor medium may be a solid-state drive.

It can be appreciated by those skilled in the art that for the specific working process of the system, the apparatus, and the unit described above, reference can be made to the corresponding process in the foregoing method embodiments, and detailed description is omitted herein for the convenience and brevity of the description.

In the embodiments of the present disclosure, the disclosed system, apparatus, and method may be implemented in other manners. For example, the embodiments of the apparatus described above are merely illustrative. For example, the division of units may only be a logical function division, and there may be other ways of dividing the units. For example, multiple units or circuits may be combined or may be integrated into another system, or some feature may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The functional units may be implemented either in hardware or in the form of software functional units.

The functional units consistent with the disclosure can be implemented in the form of computer program stored in a non-transitory computer-readable storage medium, which can be sold or used as a standalone product. Based on this understanding, the technical solution of the present disclosure, or the part that contributes to the conventional technology, or all or part of the technical solution can be embodied in the form of a software product. The computer software product can be stored in a storage medium including instructions to enable a computer device, such as a processor, a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk

The technical solutions provided by the present disclosure are described in detail above. The principle and implementation of the present disclosure are described herein using specific examples. The above description of the embodiments is merely for helping in understanding the method and the core ideas of the present disclosure. At the same time, those skilled in the art can change the specific embodiments and application scopes of the disclosure, based on the idea of the present disclosure. Therefore, the contents of the specification are not intended to limit the scope of the disclosure.

What is claimed is:

1. A lock loss recapture method comprising:
acquiring a signal transmission time range of a target satellite;
determining a code phase search range based on the signal transmission time range;
acquiring a carrier frequency search range of the target satellite; and
tracking a signal of the target satellite in response to the code phase search range satisfying a first condition and the carrier frequency search range satisfying a second condition.

2. The method of claim 1, wherein tracking the signal of the target satellite includes:
determining a current code phase based on a first rule and the code phase search range;
determining a current carrier frequency based on a second rule and the carrier frequency search range; and
tracking the signal of the target satellite based on the current code phase and the current carrier frequency.

3. The method of claim 2, further comprising, after tracking the signal of the target satellite:
acquiring a predetermined code phase and a predetermined carrier frequency;
determining that the signal of the target satellite is locked in response to, within a first time period, a code phase difference between the current code phase and the predetermined code phase being less than or equal to a first value, and a frequency difference between the current carrier frequency and the predetermined carrier frequency being less than or equal to a second value within a first time period; and
determining whether a lock loss time exceeds a second time period in response to, within the first time period, the code phase difference being greater than the first value, or the frequency difference being greater than the second value.

4. The method of claim 1, wherein acquiring the signal transmission time range of the target satellite includes:
acquiring a signal transmission time of the target satellite;
acquiring a parameter error range including an error range of a geometric distance between a receiver and the target satellite, an error range of an error parameter, and an error range of a current time; and
determining the signal transmission time range based on the signal transmission time of the target satellite and the parameter error range.

5. The method of claim 4, wherein acquiring the signal transmission time of the target satellite includes:
acquiring a current time of the receiver;
acquiring the geometric distance between the receiver and the target satellite;
estimating a pseudo-distance based on the geometric distance and the error parameter; and
determining the signal transmission time based on the pseudo-distance and the current time of the receiver.

6. The method of claim 5, wherein acquiring the geometric distance between the receiver and the target satellite includes:
acquiring receiver position information using one or more positioning devices including one or more of an inertial navigation, a visual sensor, or an ultrasound;
acquiring satellite position information of the target satellite using a satellite ephemeris acquired by the receiver and the current time of the receiver; and
acquiring the geometric distance based on the receiver position information and the satellite position information.

7. The method of claim 1, wherein determining the code phase search range based on the signal transmission time range includes:
acquiring a code period of a target satellite carrier;
acquiring a number of chips through the code period; and
obtaining the code phase search range based on the code period, the number of the chips, and the signal transmission time range.

8. The method of claim 1, wherein acquiring the carrier frequency search range of the target satellite includes:
acquiring a carrier frequency of the target satellite;
acquiring an error range of an error parameter; and
determining the carrier frequency search range based on the carrier frequency and the error range of the error parameter.

9. The method of claim 8, wherein determining the carrier frequency of the target satellite includes:
acquiring the error parameter; and
determining the carrier frequency of the target satellite based on the error parameter.

10. The method of claim 1, further comprising:
capturing the signal of the target satellite using a capturing engine or a channel correlator in response to the carrier frequency search range not satisfying the first condition.

11. The method of claim 10, further comprising:
determining whether the signal of the target satellite was successfully captured;
tracking the signal of the target satellite in response to the signal of the target satellite being successfully captured; and
determining whether a lock loss time exceeds the second time period in response to the signal of the target satellite not being successfully captured.

12. The method of claim 11, further comprising:
determining whether the lock loss time exceeds the second time period, the lock loss time being a time period from when the receiver loses the signal of the target satellite to when the receiver again successfully tracks the signal of the target satellite;
terminating the lock loss recapture in response to the lock loss time exceeding the second time period; and
expanding at least one of the carrier frequency search range or the code phase search range in response to the lock loss time not exceeding the second time period.

13. The method of claim 1, further comprising;
capturing the signal of the target satellite using a channel correlator in response to the carrier frequency search range satisfying the first condition and the code phase search range not satisfying the second condition.

14. A terminal comprising:
a memory storing a program; and
a processor configured to execute the program to:
acquire a signal transmission time range of a target satellite;
determine a code phase search range based on the signal transmission time range;
acquire a carrier frequency search range of the target satellite; and
track a signal of the target satellite in response to the code phase search range satisfying a first condition and the carrier frequency search range satisfying a second condition.

15. The terminal of claim 14, wherein the processor is further configured to execute the program to:
determine a current code phase based on a first rule and the code phase search range;
determine a current carrier frequency based on a second rule and the carrier frequency search range; and
track the signal of the target satellite based on the current code phase and the current carrier frequency.

16. The terminal of claim 15, wherein the processor is further configured to execute the program to, after tracking the signal of the target satellite:
acquire a predetermined code phase and a predetermined carrier frequency;
determine that the signal of the target satellite is locked in response to, within a first time period, a code phase difference between the current code phase and the predetermined code phase being less than or equal to a first value, and a frequency difference between the current carrier frequency and the predetermined carrier frequency being less than or equal to a second value within a first time period; and
determine whether a lock loss time exceeds a second time period in response to, within the first time period, the code phase error being greater than the first value, or the frequency difference being greater than the second value.

17. The terminal of claim 14, wherein the processor is further configured to execute the program to:
acquire a signal transmission time of the target satellite;
acquire a parameter error range including an error range of a geometric distance between a receiver and the target satellite, an error range of an error parameter, and an error range of a current time; and
determine the signal transmission time range based on the signal transmission time of the target satellite and the parameter error range.

18. The terminal of claim 17, wherein the processor is further configured to execute the program to:
acquire a current time of the receiver;
acquire the geometric distance between the receiver and the target satellite;
estimate a pseudo-distance based on the geometric distance and the error parameter; and
determine the signal transmission time based on the pseudo-distance and the current time of the receiver.

19. The terminal of claim 18, wherein the processor is further configured to execute the program to:
acquire receiver position information using one or more positioning devices including one or more of an inertial navigation, a visual sensor, or an ultrasound;
acquire satellite position information of the target satellite using a satellite ephemeris acquired by the receiver and the current time of the receiver; and
acquire the geometric distance based on the receiver position information and the satellite position information.

20. A computer-readable recording medium storing a computer program that, when executed by a computer, causes the computer to:
acquire a signal transmission time range of a target satellite;
determine a code phase search range based on the signal transmission time range;
acquire a carrier frequency search range of the target satellite; and
track a signal of the target satellite in response to the code phase search range satisfying a first condition and the carrier frequency search range satisfying a second condition.
